(19) United States
(12) Patent Application Publication
(10) Pub. No.: US 2024/0176103 A1
(43) Pub. Date: May 30, 2024

(54) ATTACHMENT OPTICAL SYSTEM, OPTICAL SYSTEM, IMAGE PICKUP APPARATUS, AND IMAGE PICKUP SYSTEM

(71) Applicant: CANON KABUSHIKI KAISHA, Tokyo (JP)

(72) Inventor: Yoshiyuki TAKI, Tochigi (JP)

(21) Appl. No.: 18/387,501

(22) Filed: Nov. 7, 2023

(30) Foreign Application Priority Data
Nov. 28, 2022 (JP) 2022-189141

(51) Int. Cl. G02B 9/12; G02B 7/02; G02B 13/02; H04N 23/54; H04N 23/63; H04N 23/69

(52) U.S. Cl. CPC G02B 9/12; G02B 7/021; G02B 13/02; H04N 23/54; H04N 23/631; H04N 23/69

(57) ABSTRACT

An attachment optical system includes a first optical system consisting of a dome-shaped cover attachable to an object side of an imaging optical system, and a second optical system attachable to an image side of the imaging optical system. A predetermined inequality is satisfied.

### BACKGROUND

### Technical Field

One of the aspects of the embodiments relates to an attachment optical system suitable for a digital video camera, a digital still camera, a broadcasting camera, a film-based film camera, a surveillance camera, and the like.

### Description of Related Art

More users have recently enjoyed underwater imaging, and an imaging lens that can be used underwater has been proposed (see Japanese Patent Laid-Open No. 2019-70705).

Aberrations change in a case where an imaging lens in which aberrations have been corrected on the assumption of atmospheric use (use in air) is placed in a dome-shaped housing and used underwater. In addition, in a case where an imaging lens having a wide angle of view such as a fisheye lens is used underwater, an angle of view is narrowed due to the influence of the dome-shaped housing.

### SUMMARY

An attachment optical system according to one aspect of the embodiment includes a first optical system consisting of a dome-shaped cover attachable to an object side of an imaging optical system, and a second optical system attachable to an image side of the imaging optical system. The following inequality is satisfied:

0.00<|fd/fc|<0.11

where fd is a focal length of the first optical system, and fc is a focal length of the second optical system. An optical system, an image pickup apparatus, and an image pickup system each having the above attachment optical system also constitute another aspect of the embodiment.

Further features of the disclosure will become apparent from the following description of embodiments with reference to the attached drawings.

### BRIEF DESCRIPTION OF THE DRAWINGS

FIGS. 1A, 1B, and 1C are sectional views of an optical system according to Example 1 at a wide-angle end (WIDE), an intermediate zoom position (MIDDLE), and a telephoto end (TELE) in an in-focus state at infinity.

FIGS. 2A, 2B, and 2C are aberration diagrams of the optical system according to Example 1 at the wide-angle end, intermediate zoom position, and telephoto end in the in-focus state at infinity.

FIGS. 3A, 3B, and 3C are sectional views of an optical system according to Example 2 at a wide-angle end, an intermediate zoom position, and a telephoto end in an in-focus state at infinity.

FIGS. 4A, 4B, and 4C are aberration diagrams of the optical system according to Example 2 at the wide-angle end, intermediate zoom position, and telephoto end in the in-focus state at infinity.

FIGS. 5A, 5B, and 5C are sectional views of an optical system according to Example 3 at a wide-angle end, an intermediate zoom position, and a telephoto end in an in-focus state at infinity.

FIGS. 6A, 6B, and 6C are aberration diagrams of the optical system according to Example 3 at the wide-angle end, intermediate zoom position, and telephoto end in the in-focus state at infinity.

FIG. 7 is a schematic diagram of an image pickup apparatus.

### DESCRIPTION OF THE EMBODIMENTS

Referring now to the accompanying drawings, a detailed description will be given of embodiments according to the disclosure. Corresponding elements in respective figures will be designated by the same reference numerals, and a duplicate description thereof will be omitted.

Prior to a description of each example, operations and effects of the present disclosure will be described. In a case where an imaging optical system designed for atmospheric use is used underwater in a waterproof dome-shaped housing, the medium outside the imaging optical system changes from air to water, the refractive index is changed, and various performances change. More specifically, the following three changes mainly occur. First, a focus position shifts from an atmospheric image plane position by the thickness of the dome-shaped housing.

Second, the negative refractive power of the dome-shaped housing causes curvature of field from an on-axis position to an off-axis position. Third, the dome-shaped housing has negative refractive power and causes negative distortion.

In addition, in case where the imaging optical system has a wide angle of view, the dome-shaped housing narrows an atmospheric angle of view.

Moving the focus lens unit of the imaging optical system can return the focus position to the image plane position, but an extension amount of the focus lens unit is reduced, and the close distance that can be maintained in air cannot be maintained. In addition, aberration fluctuations occur due to the movement of the focus lens unit.

A first converter optical system disposed between the dome-shaped housing and the imaging optical system can return the focus position to the image plane position without moving the focus lens unit. However, depending on the moving amount of the focus position, the positive refractive power of the first converter optical system increases, and a large amount of positive distortion occurs. Moreover, in a case where the imaging optical system has a wide angle of view, it becomes difficult to place the first converter optical system between the dome-shaped housing and the imaging optical system.

The second converter optical system disposed between the imaging optical system and the image plane can correct the curvature of field equivalent to the atmospheric level. However, to correct the negative distortion caused by the dome-shaped housing, strong negative refractive power toward the periphery of the second converter optical system is required. Increasing the refractive power of the second converter optical system significantly makes different an underwater moving amount of the focus position during movement of the focus lens unit from an atmospheric moving amount of the focus position, and affects autofocus (AF) performance.

From the above, the attachment optical system including the two converter optical systems requires the following conditions. The first condition is to correct changes in aberration caused by underwater use in a well-balanced manner, the second condition is to limit the extension (or moving) amount of the focus lens unit, and the third condition is to prohibit the refractive power of the rear converter lens located on the image plane side of the imaging optical system from increasing. The configuration according to each example can meet these conditions, and bring the underwater optical performance closer to the atmospheric optical performance.

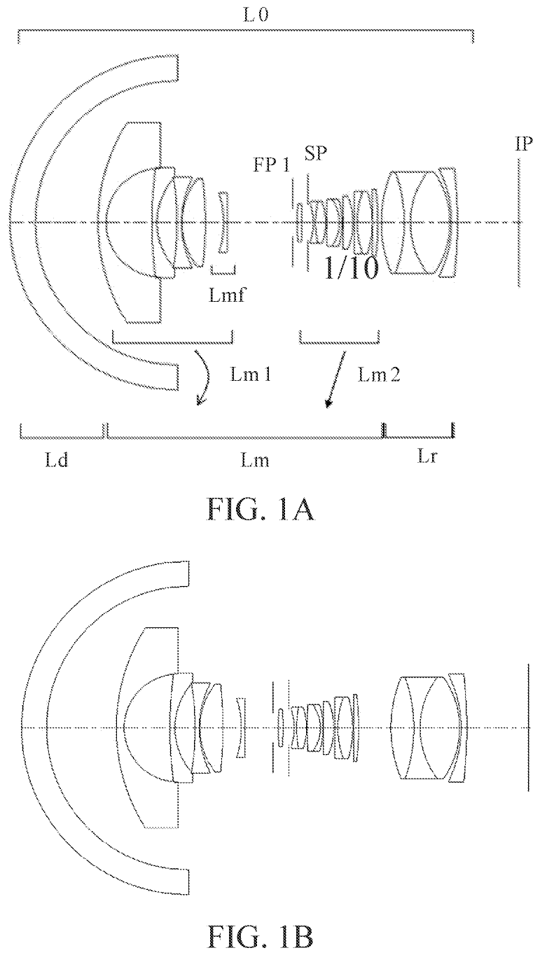

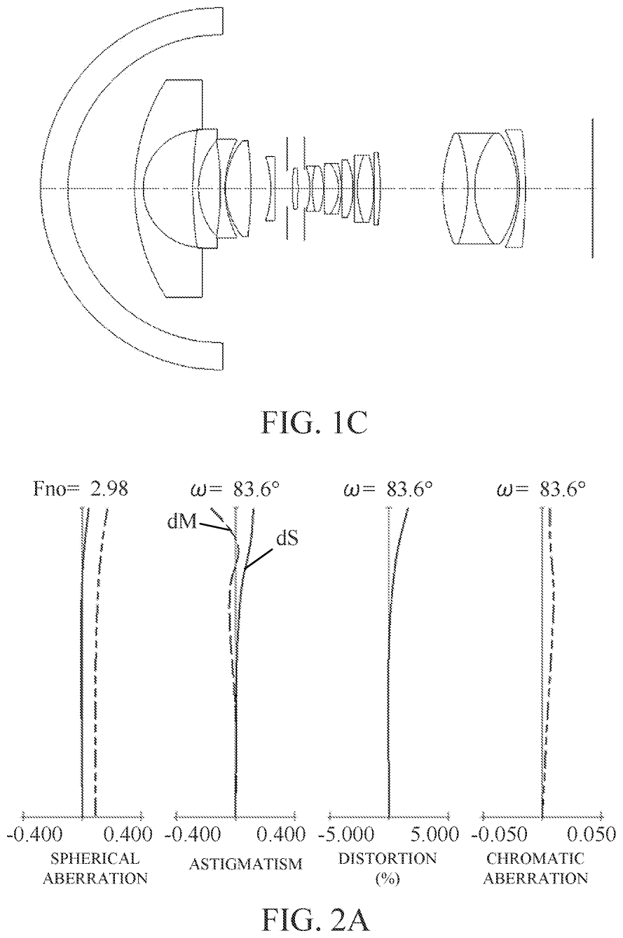

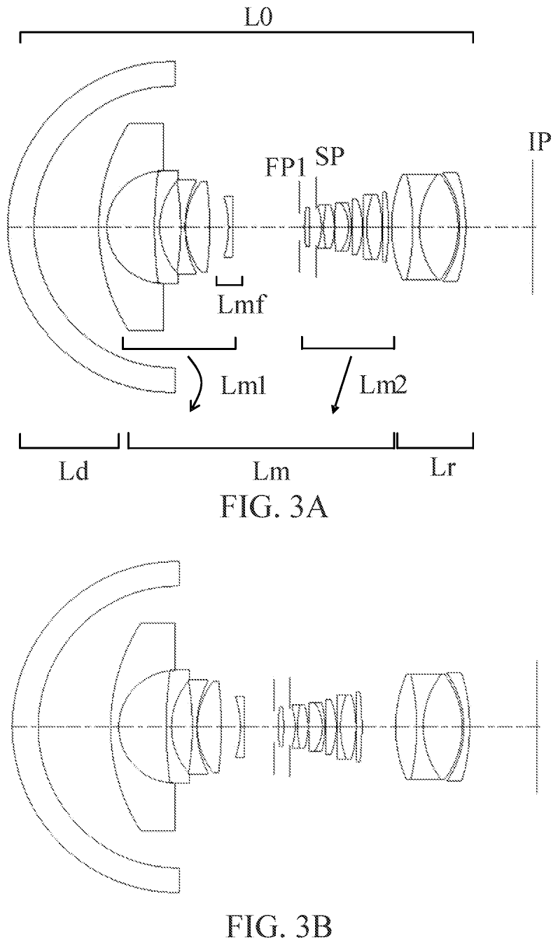

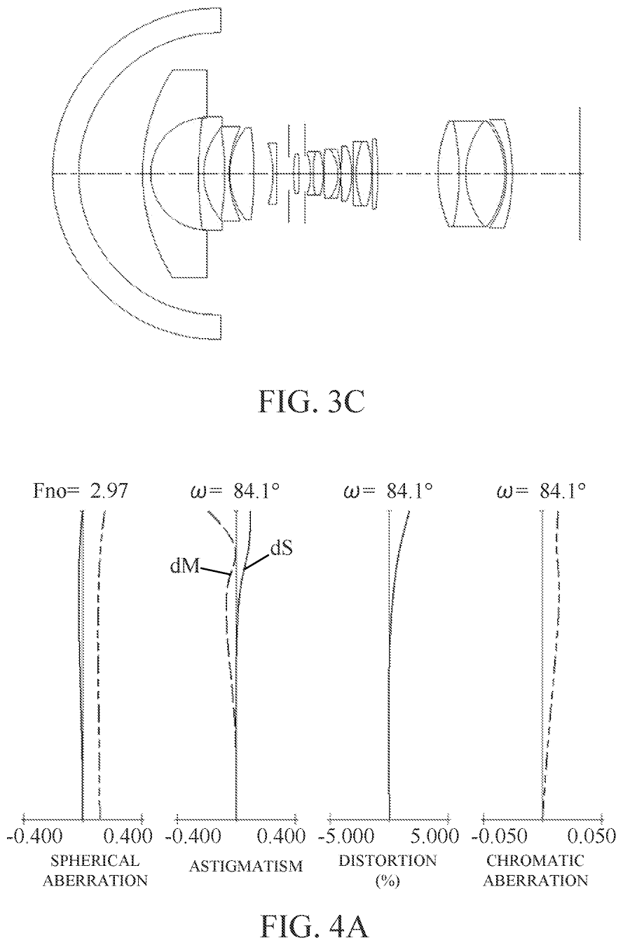

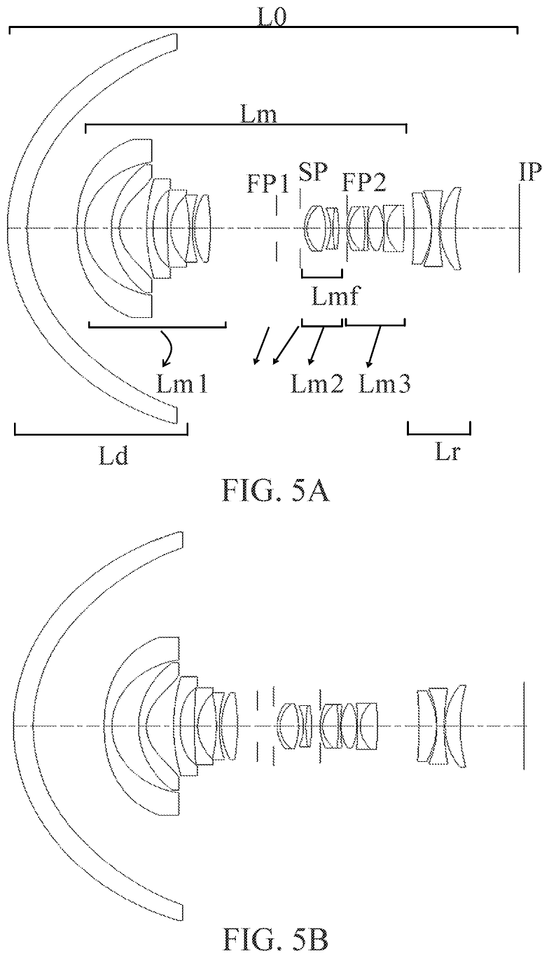

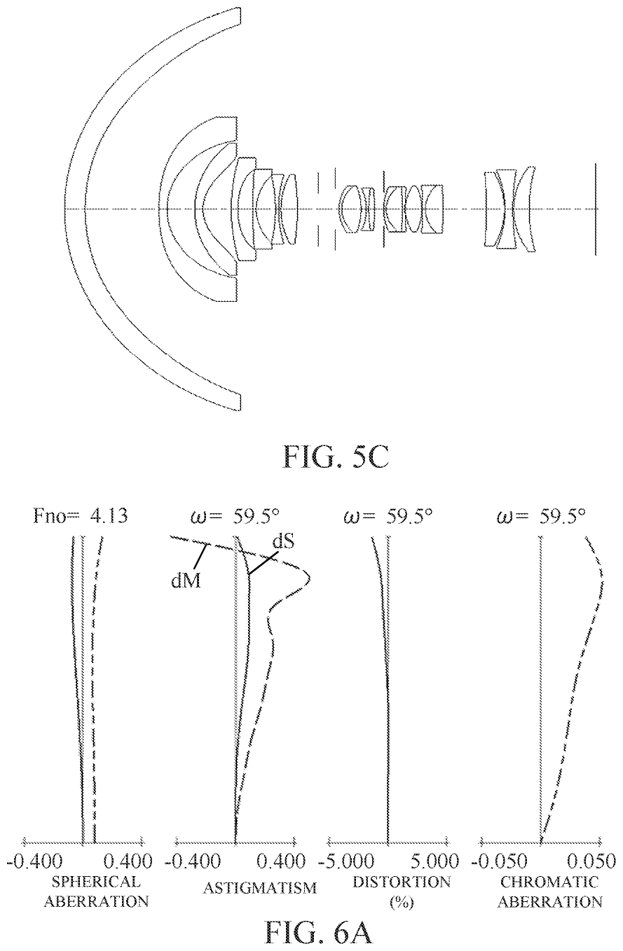

A description will now be given of the attachment optical system and the image pickup apparatus according to each example. FIGS. 1A, 3A, and 5A are sectional views of the optical systems L0 according to Examples 1 to 3 at the wide-angle ends in in-focus states at infinity. FIGS. 1B, 3B, and 5B are sectional views of the optical systems L0 according to Examples 1 to 3 at intermediate zoom positions in in-focus states at infinity. FIGS. 1C, 3C, and 5C are sectional views of the optical systems L0 according to Examples 1 to 3 at the telephoto ends in in-focus states at infinity.

In each sectional view, a left side is an object side and a right side is an image side. The optical system according to each example includes a plurality of lens units. In this specification, a lens unit is a group of lenses that move or stand still during zooming and focusing. That is, in the optical system according to each example, a distance between adjacent lens units changes during focusing from infinity to a short distance. The lens unit may include one or more lenses. The lens unit may include an aperture stop.

The optical system L0 according to each example includes, in order from the object side to the image side, a dome-shaped housing (dome-shaped cover) Ld, an imaging optical system Lm, and a rear converter lens Lr. The dome-shaped housing Ld is used adjacent to a medium such as water. That is, the dome-shaped housing Ld is used such that water is located outside the dome-shaped housing and is located inside the dome-shaped housing. The imaging optical system Lm is designed to optimize its optimal performance in air.

In each sectional view, Lmi represents an i-th (where i is a natural number) lens unit counted from the object side among lens units included in the imaging optical system Lm.

SP represents an aperture stop. IP represents an image plane, and in a case where the optical system L0 according to each example is used as an imaging optical system of a digital still camera or a digital video camera, an imaging plane of a solid-state image sensor (photoelectric conversion element) such as a CCD sensor or a CMOS sensor is placed on the image plane IP. In a case where the optical system L0 according to each example is used as an imaging optical system of a film-based camera, a photosensitive plane corresponding to the film plane is placed on the image plane IP.

The optical system L0 according to each example is configured to move at least one lens unit in the imaging optical system Lm during focusing. Hereinafter, in the imaging optical system Lm, the lens unit that moves during focusing will be referred to as a focus lens unit Lmf. An arrow illustrated in each sectional view indicates a moving direction of each lens unit during zooming from the wide-angle end to the telephoto end. The focus lens unit Lmf moves toward the object side during focusing.

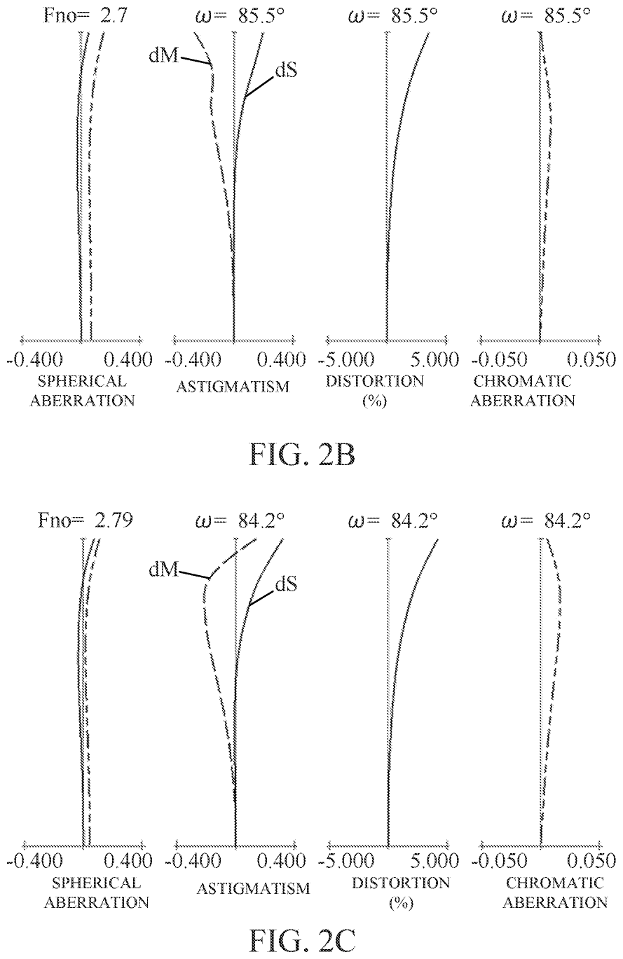

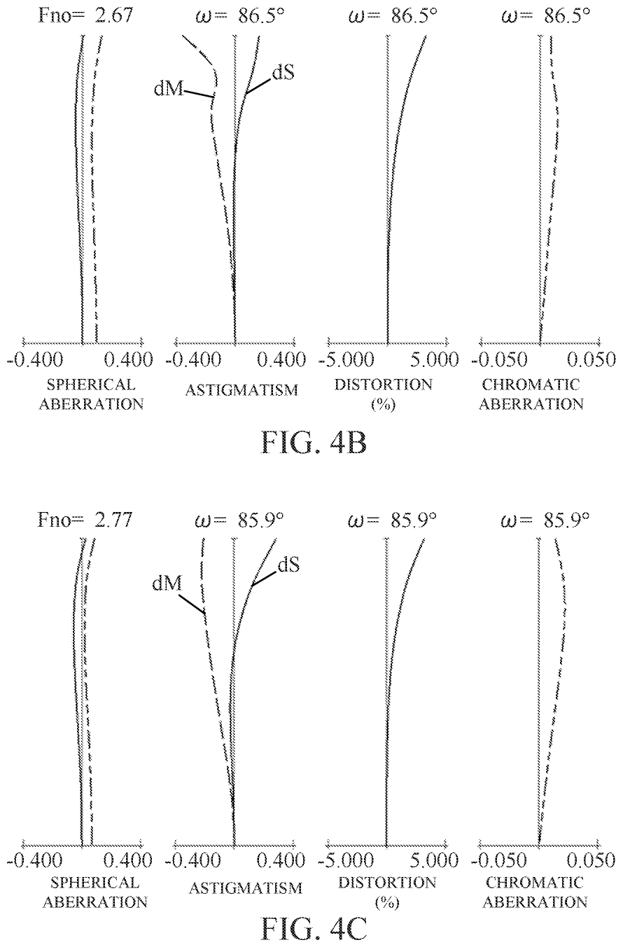

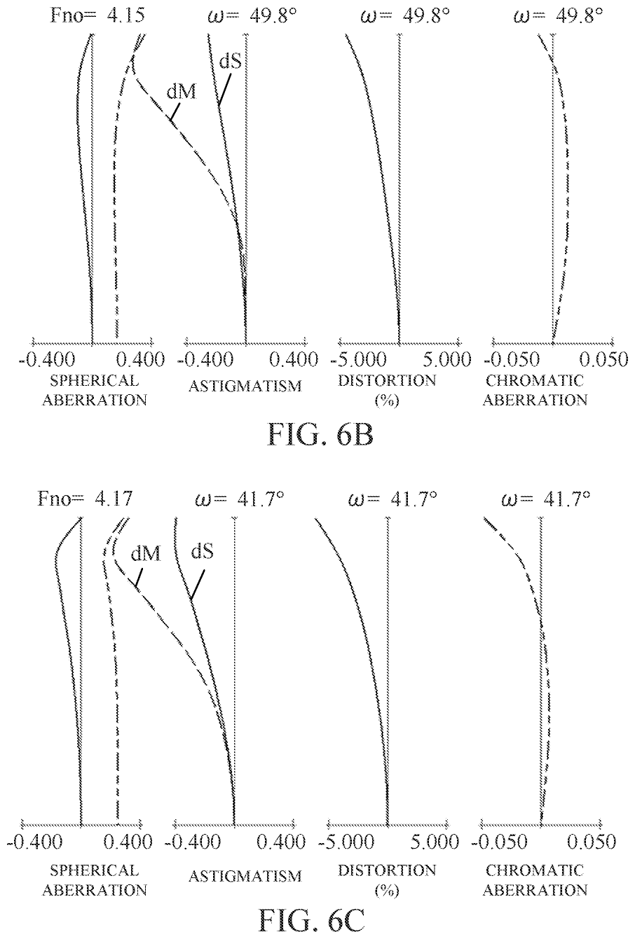

FIGS. 2A, 4A, and 6A are aberration diagrams of the optical systems L0 according to Examples 1 to 3, respectively, at the wide-angle ends in in-focus states at infinity. FIGS. 2B, 4B, and 6B are aberration diagrams of the optical systems L0 according to Examples 1 to 3, respectively, at intermediate zoom positions in in-focus states at infinity. FIGS. 2C, 4C, and 6C are aberration diagrams of the optical systems L0 according to Examples 1 to 3, respectively, at the telephoto ends in in-focus states at infinity. These aberration diagrams are calculation results in water using a refractive index of water of 1.333 for the d-line.

In a spherical aberration diagram, Fno denotes an F-number. The spherical aberration diagram illustrates spherical aberration amounts for the d-line (wavelength 587.6 nm) and g-line (wavelength 435.8 nm). In an astigmatism diagram, S indicates an astigmatism amount on a sagittal image plane, and M indicates an astigmatism amount on a meridional image plane. A distortion diagram illustrates a distortion amount for the d-line. A chromatic aberration diagram illustrates a chromatic aberration amount for the g-line. (o denotes a half angle of view (°).

A description will now be given of the characteristic configuration of the attachment optical system according to each example.

The attachment optical system according to each example includes a first optical system that consists of a dome-shaped housing Ld that can be attached to the object side of the imaging optical system Lm, and a second optical system that consists of a rear converter lens Lr that can be attached to the image side of the imaging optical system Lm.

The attachment optical system according to each example may satisfy the following inequality (1):

0.5<tkw/rd1<1.0 (1)

where tkw is a distance on the optical axis from a lens surface closest to the object of the first optical system at the wide-angle end to an entrance pupil position of an optical system including all lenses from a lens closest to an object of the first optical system to a lens closest to an image side of the second optical system, where the distance tkw is set positive in a direction from the lens surface closest to the object of the first optical system toward the image plane, rd1 is a radius of curvature of a surface on the object side of the dome-shaped housing Ld.

Inequality (1) is an inequality regarding the dome shape and a ray angle that defines a relationship between the entrance pupil position in the optical system L0 and the radius of curvature of the object-side surface of the dome-shaped housing Ld. In a case where the radius of curvature of the object-side surface of the dome-shaped housing Ld becomes larger and the value of tkw/rd1 becomes lower than the lower limit of inequality (1), the underwater imaging angle of view of the optical system L0 becomes narrower than the atmospheric imaging angle. In a case where the radius of curvature of the object-side surface of the dome-shaped housing Ld becomes smaller and the value of tkw/rd1 becomes higher than the upper limit of inequality (1), a moving amount of the focus position relative to an underwater moving amount of the focus lens unit Lmf (focus sensitivity) becomes larger than the atmospheric focus sensitivity. Therefore, AF performance deteriorates.

Inequality (1) may be replaced with inequality (1a) below:

0.6<tkw/rd1<1.0 (1a)

Inequality (1) may be replaced with inequality (1b) below:

0.605<tkw/rd1<1.000 (1b)

The attachment optical system according to each example satisfies the following inequality (2):

0.0<|fd/fc|<0.11 (2)

where fd is a focal length of the first optical system, and fc is a focal length of the second optical system.

Inequality (2) is an inequality regarding a proper refractive power arrangement that defines a relationship between the focal length of the first optical system and the focal length of the second optical system. In a case where the refractive power of the second optical system becomes weaker and the value of |fd/fc| becomes higher than the upper limit of inequality (2), it becomes difficult to correct various aberrations underwater.

Inequality (2) may be replaced with inequality (2a) below:

0.03<|fd/fc|<0.10 (2a)

In a case where the refractive power of the second optical system becomes stronger and the value of |fd/fc| becomes lower than the lower limit of inequality (2a), the optical system L0 becomes larger.

Inequality (2) may be replaced with inequality (2b) below:

0.035<|fd/fc|<0.095 (2b)

A description will now be given of the conditions that the attachment optical system and the optical system L0 according to each example may satisfy. The attachment optical system and optical system L0 according to each example may satisfy one or more of the following inequalities (3) to (7):

10<|(rd2+rd1)/(rd2−rd1)|<60 (3)

0.7<|(rd1−rd2)/Dd|≤1.0 (4)

1.0<|skcw/skmw|<1.2 (5)

0.3<dxw/dxt<1.0 (6)

110<2ω≤180 (7)

Here, rd2 is a radius of curvature of a surface on the image side of the dome-shaped housing Ld. Dd is a thickness of the dome-shaped housing Ld on the optical axis (distance on the optical axis from the object-side surface of the dome-shaped housing Ld to the image-side surface of the dome-shaped housing Ld). skcw is an underwater distance on the optical axis from the lens surface closest to the image side of the imaging optical system Lm having the attachment optical system at the wide-angle end to the image plane. skmw is an atmospheric distance on the optical axis from a lens surface closest to the image plane of the imaging optical system Lm having the attachment optical system at the wide-angle end to the image plane. dxw is an underwater moving amount of the focus lens unit Lmf relative to the atmospheric position at the wide-angle end in an in-focus state at infinity. dxt is an underwater moving amount of the focus lens unit Lmf relative to the atmospheric position at the telephoto end in an in-focus state at infinity. ω is an atmospheric half angle of view of the imaging optical system Lm.

Inequality (3) is an inequality regarding refraction of an off-axis ray of the imaging optical system Lm, which defines the shape of the dome-shaped housing Ld. In a case where the underwater refractive power of the dome-shaped housing Ld increases and the value of |(rd2+rd1)/(rd2−rd1) becomes lower than the lower limit of inequality (3), it becomes difficult to focus on the shortest imaging distance by moving the focus lens unit Lmf. In addition, it becomes difficult to correct various aberrations. In a case where the dome-shaped housing Ld approaches the parallel plate and the value of |(rd2+rd1)/(rd2−rd1) becomes higher than the upper limit of inequality (3), the underwater imaging angle of view becomes narrower than the atmospheric imaging angle of view.

Inequality (4) relates to the shape of the image-side surface of the dome-shaped housing Ld. Exceeding the upper and lower limits of inequality (4) means that the shape of the dome-shaped housing Ld departs from the spherical shape, and an off-axis ray of the imaging optical system Lm is significantly refracted by the dome-shaped housing Ld, and the underwater imaging angle of view is narrower than the atmospheric imaging angle of view.

Inequality (5) is an inequality regarding an overall length change due to the rear converter lens Lr, which defines the distance on the optical axis from a lens surface closest to the image plane to the image plane of the imaging optical system Lm at the wide-angle end before and after the rear converter lens Lr is attached. In a case where the rear converter lens Lr is smaller and the value of |skcw/skmw| becomes lower than the lower limit of inequality (5), it will be difficult to correct various aberrations underwater. In a case where the rear converter lens Lr is larger and the value of |skcw/skmw| becomes higher than the upper limit of inequality (5), the optical system L0 becomes larger.

Inequality (6) is an inequality regarding the underwater refractive power of the dome-shaped housing Ld that defines the underwater positions of the focus lens unit Lmf at the wide-angle end and the telephoto end in an in-focus state at infinity. The focus lens unit Lmf is extended (moved) in the short-distance direction in comparison with an atmospheric case in accordance with the underwater change in the focus position by the dome-shaped housing Ld. In a case where the moving amount of the focus lens unit Lmf at the telephoto end becomes large and the value of dxw/dxt becomes lower than the lower limit of inequality (6), it becomes difficult to focus on the atmospheric shortest imaging distance. The underwater refractive power of the dome-shaped housing Ld is strong, and it becomes difficult to correct various aberrations. In a case where the refractive power of the dome-shaped housing Ld becomes weaker and the value of dxw/dxt becomes higher than the upper limit of inequality (6), the underwater imaging angle of view becomes narrower.

Inequality (7) is an inequality regarding the atmospheric angle of view of the imaging optical system Lm. In a case where the value of 2ω becomes lower than the lower limit of inequality (7), the imaging angle of view is small. In a case where the value of 2ω becomes higher than the upper limit of inequality (7), the imaging optical system Lm cannot be produced.

Inequalities (3) to (7) may be replaced with the following inequalities (3a) to (7a):

10<|(rd2+rd1)/(rd2−rd1)|<40 (3a)

0.8<|(rd1−rd2)/Dd|≤1.0 (4a)

1.02<|skcw/skmw|<1.17 (5a)

0.3<dxw/dxt<0.9 (6a)

160<2ω≤180 (7a)

Inequalities (3) to (7) may be replaced with the following inequalities (3b) to (7b):

10<|(rd2+rd1)/(rd2−rd1)|<30 (3b)

0.9<|(rd1−rd2)/Dd|≤1.0 (4b)

1.03<|skcw/skmw|<1.16 (5b)

0.3<dxw/dxt<0.8 (6b)

170<2ω≤180 (7b)

A detailed description will be given of the optical system L0 according to each example.

In Examples 1 and 2, the imaging optical system Lm includes, in order from the object side to the image side, a first lens unit Lm1 having negative refractive power, and a second lens unit Lm2 having positive refractive power. During focusing from the infinity to a close distance, the focus lens unit Lmf included in the first lens unit Lm1 moves toward the object side. During zooming from the wide-angle end to the telephoto end, the first lens unit Lm1 moves along a locus that is convex toward the image side, and the second lens unit Lm2 moves toward the object side. FP1 is an auxiliary diaphragm (aperture stop).

In Example 3, the imaging optical system Lm includes, in order from the object side to the image side, a first lens unit Lm1 having negative refractive power, a second lens unit Lm2 having positive refractive power, and a third lens unit Lm3 having positive refractive power. During focusing from the infinity to a close distance, the focus lens unit Lmf included in the second lens unit Lm2 moves toward the image side. During zooming from the wide-angle end to the telephoto end, the first lens unit Lm1 moves along a locus that is convex toward the image side, and the second lens unit Lm2 and the third lens unit Lm3 move toward the object side along different loci. FP1 and FP2 are flare cut diaphragms (aperture stops). The aperture stop SP moves independently of each lens unit.

In each example, the dome-shaped housing Ld and rear converter lens Lr are fixed (not moving) during zooming and focusing.

Numerical examples 1 to 3 corresponding to examples 1 to 3 will be illustrated below.

In surface data of each numerical example, r represent a radius of curvature of each optical surface, and d (mm) represents an on-axis distance (distance on the optical axis) between an m-th surface and an (m+1)-th surface, where m is a surface number counted from the light incident side. nd represents a refractive index for the d-line of each optical element, and νd represents an Abbe number of the optical element based on the d-line. The Abbe number νd of a certain material is expressed as follows:

νd=(Nd−1)/(NF−NC)

where Nd, NF, and NC are refractive indices based on the d-line (587.6 nm), the F-line (486.1 nm), and the C-line (656.3 nm) in the Fraunhofer line, respectively.

In each numerical example, values of d, a focal length (mm), an F-number, and a half angle of view (°) are set in a case where the optical system according to each example is in the in-focus state on the infinity object. A back focus is a distance on the optical axis from the final lens surface (lens surface closest to the image plane) of the zoom lens L0 to the paraxial image plane expressed in air conversion length. The overall lens length of the zoom lens L0 is a length obtained by adding the back focus to a distance on the optical axis from the first lens surface (lens surface closest to the object) to the final lens surface.

In a case where the optical surface is aspherical, an asterisk * is attached to the right side of the surface number. The aspherical shape is expressed as follows:

X=(h²/R)/[1+{1−(1+K)(h/R)²}^{1/2}]+A4×h⁴+A6×h⁶+A8×h⁸+A10×h¹⁰+A12×h¹²+A14×h¹⁴

where X is a displacement amount from a surface vertex in the optical axis direction, h is a height from the optical axis in a direction orthogonal to the optical axis, a light traveling direction is set positive, R is a paraxial radius of curvature, K is a conic constant, and A4, A6, A8, A10, A12, and A14 are aspheric coefficients. “e±XX” in each aspheric coefficient means “×10^{±XX}.”

### Numerical Example 1

UNIT: mm
SURFACE DATA

| Surface | | | | | Effective |
|---|---|---|---|---|---|
| No. | r | d | nd | νd | Diameter |
| 1 | 53.398 | 8 | 1.51633 | 64.1 | 150 |
| 2 | 45.395 | (Variable) | 1 | 0 | 130 |
| 3 | 59.84 | 2.5 | 1.804 | 46.6 | 61.95 |
| 4 | 17.282 | 14.64 | 1 | 0 | 35.19 |
| 5 | 129.723 | 1.61 | 1.59282 | 68.6 | 33.1 |
| 6 | 21.61 | 6.44 | 1 | 0 | 27.48 |
| 7 | −86.935 | 1.36 | 1.59282 | 68.6 | 27.23 |
| 8 | 31.102 | 0.15 | 1 | 0 | 26.09 |
| 9 | 22.525 | 7.45 | 1.80518 | 25.4 | 26.08 |
| 10 | −110.226 | 5.82 | 1 | 0 | 24.72 |
| 11* | −31.089 | 1.2 | 1.85135 | 40.1 | 17.73 |
| 12 | −844.34 | (Variable) | 1 | 0 | 17.01 |
| 13 | ∞ | 1.46 | 1 | 0 | 10.19 |
| 14 | 43.413 | 1.62 | 1.883 | 40.8 | 10.87 |
| 15 | −94.26 | 1.85 | 1 | 0 | 10.94 |
| 16 (SP) | ∞ | 1.7 | 1 | 0 | 10.95 |
| 17 | −19.292 | 0.75 | 1.883 | 40.8 | 10.96 |
| 18 | 32.493 | 3.22 | 1.51823 | 58.9 | 11.53 |
| 19 | −20.261 | 0.2 | 1 | 0 | 12.31 |
| 20 | 194.716 | 4.25 | 1.48749 | 70.2 | 12.74 |
| 21 | −12.377 | 0.8 | 1.883 | 40.8 | 13.21 |
| 22 | −27.182 | 0.2 | 1 | 0 | 13.96 |
| 23 | 712.893 | 3.28 | 1.5927 | 35.3 | 14.77 |
| 24 | −21.62 | 0.35 | 1 | 0 | 15.88 |
| 25 | −60941.798 | 0.93 | 1.834 | 37.2 | 16.91 |
| 26 | 28.231 | 4.77 | 1.497 | 81.5 | 17.6 |
| 27 | −34.279 | 0.2 | 1 | 0 | 18.7 |
| 28 | −80910.795 | 1.68 | 1.48749 | 70.2 | 19.49 |
| 29 | −87.072 | (Variable) | 1 | 0 | 19.87 |
| 30 | 41.951 | 7.33 | 1.5927 | 35.3 | 31 |
| 31 | −47.975 | 2 | 1.883 | 40.8 | 31 |
| 32 | 26.637 | 12.64 | 1.57099 | 50.8 | 31 |
| 33 | −28.049 | 0.47 | 1 | 0 | 31 |
| 34 | −38.014 | 1.79 | 1.883 | 40.8 | 33 |
| 35 | −155.828 | (Variable) | 1 | 0 | 33 |
| Image Plane | ∞ | | | | |

ASPHERIC DATA

11th Surface
K = 0.00E+00 A4 = −7.40657E−06 A6 = 8.37176E−08
A8 = −1.88131E−09 A10 = 1.86883E−11 A12 = −6.91434E−14

VARIOUS DATA

| | |
|---|---|
| ZOOM RATIO | 1.93 |

| | WIDE | MIDDLE | TELE |
|---|---|---|---|
| Focal Length | 5.92 | 8.69 | 11.4 |
| Fno | 2.98 | 2.7 | 2.79 |
| Half Angle of View (°) | 167.3 | 170.9 | 168.4 |
| Image Height | 10.58 | 15.91 | 20.52 |
| Overall Lens Length | 162.1 | 162.1 | 162.1 |
| BF | 19.75 | 19.75 | 19.75 |
| d2 | 20 | 22.31 | 19.59 |
| d12 | 20.69 | 9.06 | 3.7 |
| d29 | 0.99 | 10.32 | 18.4 |
| d35 | 19.75 | 19.75 | 19.75 |
| Entrance Pupil Position | 50.08 | 51.87 | 49.74 |
| Exit Pupil Position | 0.23 | −8.08 | −15.32 |
| Front Principal Point Position | 55.61 | 59.94 | 60.19 |
| Rear Principal Point Position | 14.13 | 11.87 | 9.79 |

ZOOM LENS UNIT DATA

| Lens | Starting | Focal | Lens Structure | Front Principal | Rear Principal |
|---|---|---|---|---|---|
| Unit | Surface | Length | Length | Point Position | Point Position |
| 1 | 1 | −129.27 | 8 | 10.34 | 2.34 |
| 2 | 3 | −10.91 | 41.17 | 10.51 | −15.41 |
| 3 | 13 | 26.8 | 27.26 | 15.9 | −6.31 |
| 4 | 30 | 2309.13 | 24.23 | −125.87 | −134.51 |

FIXED FOCAL LENGTH LENS DATA

| Lens | Starting Surface | Focal Length |
|---|---|---|
| 1 | 1 | −129.27 |
| 2 | 3 | −31.04 |
| 3 | 5 | −43.98 |
| 4 | 7 | −38.48 |
| 5 | 9 | 23.82 |
| 6 | 11 | −37.94 |
| 7 | 14 | 33.85 |
| 8 | 17 | −13.62 |
| 9 | 18 | 24.59 |
| 10 | 20 | 24.03 |
| 11 | 21 | −26.4 |
| 12 | 23 | 35.46 |
| 13 | 25 | −33.83 |
| 14 | 26 | 31.96 |
| 15 | 28 | 178.8 |
| 16 | 30 | 38.94 |
| 17 | 31 | −19.16 |
| 18 | 32 | 26.12 |
| 19 | 34 | −57.35 |

### Numerical Example 2

UNIT: mm
SURFACE DATA

| Surface | | | | | Effective |
|---|---|---|---|---|---|
| No. | r | d | nd | νd | Diameter |
| 1 | 51.058 | 8 | 1.51633 | 64.1 | 150 |
| 2 | 43.496 | (Variable) | 1 | 0 | 130 |
| 3 | 59.84 | 2.5 | 1.804 | 46.6 | 61.95 |
| 4 | 17.282 | 14.64 | 1 | 0 | 35.19 |
| 5 | 129.723 | 1.61 | 1.59282 | 68.6 | 33.1 |
| 6 | 21.61 | 6.44 | 1 | 0 | 27.48 |
| 7 | −86.935 | 1.36 | 1.59282 | 68.6 | 27.23 |
| 8 | 31.102 | 0.15 | 1 | 0 | 26.09 |
| 9 | 22.525 | 7.45 | 1.80518 | 25.4 | 26.08 |
| 10 | −110.226 | 5.82 | 1 | 0 | 24.72 |
| 11* | −31.089 | 1.2 | 1.85135 | 40.1 | 17.73 |
| 12 | −844.34 | (Variable) | 1 | 0 | 17.01 |
| 13 | ∞ | 1.46 | 1 | 0 | 10.19 |
| 14 | 43.413 | 1.62 | 1.883 | 40.8 | 10.87 |
| 15 | −94.26 | 1.85 | 1 | 0 | 10.94 |
| 16 (SP) | ∞ | 1.7 | 1 | 0 | 10.95 |
| 17 | −19.292 | 0.75 | 1.883 | 40.8 | 10.96 |
| 18 | 32.493 | 3.22 | 1.51823 | 58.9 | 11.53 |
| 19 | −20.261 | 0.2 | 1 | 0 | 12.31 |
| 20 | 194.716 | 4.25 | 1.48749 | 70.2 | 12.74 |
| 21 | −12.377 | 0.8 | 1.883 | 40.8 | 13.21 |
| 22 | −27.182 | 0.2 | 1 | 0 | 13.96 |
| 23 | 712.893 | 3.28 | 1.5927 | 35.3 | 14.77 |
| 24 | −21.62 | 0.35 | 1 | 0 | 15.88 |
| 25 | −60941.798 | 0.93 | 1.834 | 37.2 | 16.91 |
| 26 | 28.231 | 4.77 | 1.497 | 81.5 | 17.6 |
| 27 | −34.279 | 0.2 | 1 | 0 | 18.7 |
| 28 | −80910.795 | 1.68 | 1.48749 | 70.2 | 19.49 |
| 29 | −87.072 | (Variable) | 1 | 0 | 19.87 |
| 30 | 41.018 | 6.53 | 1.5927 | 35.3 | 31 |
| 31 | −71.713 | 2 | 1.883 | 40.8 | 31 |
| 32 | 26.325 | 12 | 1.51742 | 52.4 | 31 |
| 33 | −26.679 | 0.5 | 1 | 0 | 31 |
| 34 | −28.933 | 1.79 | 1.883 | 40.8 | 32 |
| 35* | −63.145 | (Variable) | 1 | 0 | 32 |
| Image Plane | ∞ | | | | |

ASPHERIC DATA

11th Surface
K = 0.00E+00 A4 = −7.40657E−06 A6 = 8.37176E−08
A8 = −1.88131E−09 A10 = 1.86883E−11 A12 = −6.91434E−14
35th Surface
K = 0.00E+00 A4 = −3.39923E−06 A6 = 1.09601E−09
A8 = −7.01207E−12

VARIOUS DATA

| | |
|---|---|
| ZOOM RATIO | 1.93 |

| | WIDE | MIDDLE | TELE |
|---|---|---|---|
| Focal Length | 5.88 | 8.63 | 11.33 |
| Fno | 2.97 | 2.67 | 2.77 |
| Half Angle of View (°) | 168.2 | 173.0 | 171.8 |
| Image Height | 10.58 | 15.91 | 20.52 |
| Overall Lens Length | 161.64 | 161.64 | 161.64 |
| BF | 20.7 | 20.7 | 20.7 |
| d2 | 20 | 22.31 | 19.59 |
| d12 | 20.69 | 9.06 | 3.7 |
| d29 | 0.99 | 10.32 | 18.4 |
| d35 | 20.7 | 20.7 | 20.7 |
| Entrance Pupil Position | 49.72 | 51.47 | 49.39 |
| Exit Pupil Position | 0.93 | −7.55 | −14.99 |
| Front Principal Point Position | 55.26 | 59.56 | 59.89 |
| Rear Principal Point Position | 15.12 | 12.9 | 10.85 |

ZOOM LENS UNIT DATA

| Lens | Starting | Focal | Lens Structure | Front Principal | Rear Principal |
|---|---|---|---|---|---|
| Unit | Surface | Length | Length | Point Position | Point Position |
| 1 | 1 | −124.13 | 8 | 10.36 | 2.35 |
| 2 | 3 | −10.91 | 41.17 | 10.51 | −15.41 |
| 3 | 13 | 26.8 | 27.26 | 15.9 | −6.31 |
| 4 | 30 | 1346.84 | 22.82 | −52.89 | −65.7 |

FIXED FOCAL LENGTH LENS DATA

| Lens | Starting Surface | Focal Length |
|---|---|---|
| 1 | 1 | −124.13 |
| 2 | 3 | −31.04 |
| 3 | 5 | −43.98 |
| 4 | 7 | −38.48 |
| 5 | 9 | 23.82 |
| 6 | 11 | −37.94 |
| 7 | 14 | 33.85 |
| 8 | 17 | −13.62 |
| 9 | 18 | 24.59 |
| 10 | 20 | 24.03 |
| 11 | 21 | −26.4 |
| 12 | 23 | 35.46 |
| 13 | 25 | −33.83 |
| 14 | 26 | 31.96 |
| 15 | 28 | 178.8 |
| 16 | 30 | 44.99 |
| 17 | 31 | −21.6 |
| 18 | 32 | 27.75 |
| 19 | 34 | −61.99 |

### Numerical Example 3

UNIT: mm
SURFACE DATA

| Surface | | | | | Effective |
|---|---|---|---|---|---|
| No. | r | d | nd | νd | Diameter |
| 1 | 100 | 8 | 1.51633 | 64.1 | 185 |
| 2* | 92 | (Variable) | 1 | 0 | 170 |
| 3* | 100.402 | 3.1 | 1.7725 | 49.6 | 83.99 |
| 4 | 32.787 | 10.7 | 1 | 0 | 62.1 |
| 5 | 42.207 | 3.2 | 1.58443 | 59.4 | 59.67 |
| 6* | 20.133 | 10.96 | 1 | 0 | 49.61 |
| 7 | 100.037 | 2.6 | 1.85 | 40.3 | 46.09 |
| 8* | 47.753 | 5.77 | 1 | 0 | 36.38 |
| 9 | 313.541 | 1.3 | 1.59522 | 67.7 | 35.84 |
| 10 | 24.146 | 7.54 | 1 | 0 | 30.95 |
| 11 | −76.811 | 1.15 | 1.43875 | 94.9 | 30.84 |
| 12 | 64.103 | 0.89 | 1 | 0 | 30.46 |
| 13 | 39.327 | 6.4 | 1.72047 | 34.7 | 30.67 |
| 14 | −123.615 | (Variable) | 1 | 0 | 29.97 |
| 15 | ∞ | (Variable) | 1 | 0 | 17.72 |
| 16 (SP) | ∞ | (Variable) | 1 | 0 | 18.91 |
| 17 | 20.914 | 1.1 | 2.001 | 29.1 | 20.11 |
| 18 | 15.6 | 7.47 | 1.57501 | 41.5 | 19.38 |
| 19 | −34.531 | 2.04 | 1 | 0 | 19.13 |
| 20 | −26.292 | 0.9 | 1.91082 | 35.3 | 18.24 |
| 21 | 68.346 | 2.28 | 1.80518 | 25.4 | 18.57 |
| 22 | −87.663 | (Variable) | 1 | 0 | 18.72 |
| 23 | ∞ | 0 | 1 | 0 | 18.98 |
| 24 | 29.727 | 0.95 | 1.883 | 40.8 | 19.07 |
| 25 | 14.164 | 6.33 | 1.51742 | 52.4 | 18.3 |
| 26 | −97.092 | 0.95 | 1.83481 | 42.7 | 18.4 |
| 27 | 117.819 | 0.15 | 1 | 0 | 18.52 |
| 28 | 22.677 | 6.42 | 1.497 | 81.5 | 19.06 |
| 29 | −27.253 | 0.2 | 1 | 0 | 19.64 |
| 30 | −210.616 | 1.1 | 1.883 | 40.8 | 19.59 |
| 31 | 16.507 | 7 | 1.58313 | 59.4 | 19.72 |
| 32* | −89.025 | (Variable) | 1 | 0 | 20.89 |
| 33 | −237.572 | 7 | 1.60342 | 38 | 33 |
| 34 | −38.526 | 0.19 | 1 | 0 | 33 |
| 35 | −51.08 | 3 | 1.83481 | 42.7 | 35 |
| 36 | 126.831 | 0.33 | 1 | 0 | 35 |
| 37 | 36.445 | 6 | 1.59551 | 39.2 | 38 |
| 38 | 85.555 | (Variable) | 1 | 0 | 38 |
| Image Plane | ∞ | | | | |

ASPHERIC DATA

2nd Surface
K = 0.00E+00 A4 = 2.57898E−07 A6 = −4.15058E−11 A8 = 6.13846E−16
3rd Surface
K = 0.00E+00 A4 = 5.07039E−06 A6 = −3.66524E−09 A8 = 2.14684E−12
A10 = −1.59746E−16 A12 = −3.49877E−19 A14 = 1.41029E−22
6th Surface
K = −3.09E+00 A4 = 3.79875E−05 A6 = −6.27286E−08 A8 = 1.29970E−11
A10 = 1.49707E−14
8th Surface
K = 0.00E+00 A4 = 1.15171E−05 A6 = −2.29358E−09 A8 = 2.08815E−10
A10 = −7.57344E−13 A12 = 1.20672E−15
32nd Surface
K = 0.00E+00 A4 = 1.96961E−05 A6 = 3.33943E−08 A8 = 2.90343E−11
A10 = −2.00200E−13 A12 = 7.23046E−15

VARIOUS DATA

| | |
|---|---|
| ZOOM RATIO | 2.05 |

| | WIDE | MIDDLE | TELE |
|---|---|---|---|
| Focal Length | 9.74 | 14.62 | 19.98 |
| Fno | 4.13 | 4.15 | 4.17 |
| Half Angle of View (°) | 65.77 | 55.96 | 47.28 |
| Image Height | 21.64 | 21.64 | 21.64 |
| Overall Lens Length | 205.71 | 205.71 | 205.71 |
| BF | 25.76 | 25.76 | 25.76 |
| d2 | 20 | 28.61 | 26.14 |
| d14 | 26.47 | 7.95 | 0.51 |
| d15 | 9.51 | 6.65 | 3.8 |
| d16 | 1.74 | 1.51 | 1.29 |
| d22 | 3.29 | 3.52 | 3.74 |
| d32 | 3.91 | 16.69 | 29.44 |
| d38 | 25.76 | 25.76 | 25.76 |
| Entrance Pupil Position | 61.01 | 68.19 | 65.05 |
| Exit Pupil Position | −50.68 | −63.11 | −75.47 |
| Front Principal Point Position | 72.34 | 84.49 | 86.5 |
| Rear Principal Point Position | 16.13 | 11.78 | 7.2 |

ZOOM LENS UNIT DATA

| Lens | Starting | Focal | Lens Structure | Front Principal | Rear Principal |
|---|---|---|---|---|---|
| Unit | Surface | Length | Length | Point Position | Point Position |
| 1 | 1 | −268.45 | 8 | 10.6 | 2.6 |
| 2 | 3 | −18.22 | 53.61 | 12.07 | −36.29 |
| 3 | 15 | ∞ | 0 | 0 | 0 |
| 4 | 16 | ∞ | 0 | 0 | 0 |
| 5 | 17 | 70.91 | 13.79 | −7.34 | −15.09 |
| 6 | 23 | 56.82 | 23.1 | 5.51 | −9.98 |
| 7 | 33 | −7004.75 | 16.52 | 69.68 | 59.02 |

FIXED FOCAL LENGTH LENS DATA

| Lens | Starting Surface | Focal Length |
|---|---|---|
| 1 | 1 | −268.45 |
| 2 | 3 | −64.31 |
| 3 | 5 | −69.59 |
| 4 | 7 | −110 |
| 5 | 9 | −44.03 |
| 6 | 11 | −79.44 |
| 7 | 13 | 42.1 |
| 8 | 17 | −68.42 |
| 9 | 18 | 19.76 |
| 10 | 20 | −20.75 |
| 11 | 21 | 48.01 |
| 12 | 24 | −31.54 |
| 13 | 25 | 24.36 |
| 14 | 26 | −63.63 |
| 15 | 28 | 26.02 |
| 16 | 30 | −17.3 |
| 17 | 31 | 24.48 |
| 18 | 33 | 75.21 |
| 19 | 35 | −43.29 |
| 20 | 37 | 101.97 |

TABLE below summarizes various values in each example.

| | Numerical | Numerical | Numerical |
|---|---|---|---|
| | Example 1 | Example 2 | Example 3 |
| Inequality (1) | 0.938 | 0.974 | 0.610 |
| Inequality (2) | 0.056 | 0.092 | 0.038 |
| Inequality (3) | 12.3 | 12.5 | 24.0 |
| Inequality (4) | 1.00 | 0.95 | 1.00 |
| Inequality (5) | 1.04 | 1.11 | 1.15 |
| Inequality (6) | 0.77 | 0.83 | 0.31 |
| Inequality (7) | 179.3 | 177.9 | 119.0 |

### Image Pickup Apparatus

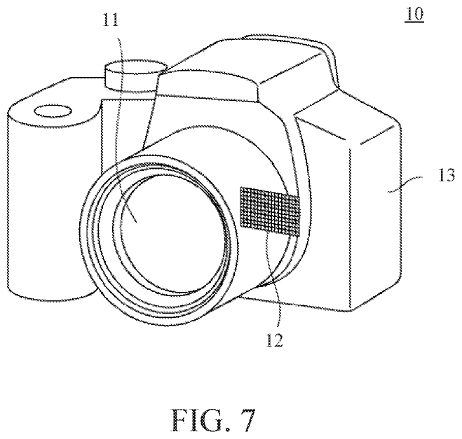

Referring now to FIG. 7, a description will be given of a digital still camera (image pickup apparatus) 10 using the optical system L0 according to each example as an imaging optical system. In FIG. 7, reference numeral 13 denotes a camera body, and reference numeral 11 denotes an imaging optical system including the optical system L0 according to any one of Examples 1 to 3. Reference numeral 12 denotes a solid image sensor (photoelectric conversion element) such as a CCD sensor or CMOS sensor, which is built in the camera body 13 and receives and photoelectrically converts an optical image formed by the imaging optical system 11. The camera body 13 may be a so-called single-lens reflex camera having a quick turn mirror, or a so-called mirrorless camera without a quick turn mirror.

Applying the optical system L0 according to each example to an image pickup apparatus such as a digital still camera can provide an image pickup apparatus having a compact lens. Applying the optical system L0 with the attachment optical system to the image pickup apparatus can realize high optical performance even underwater.

### Image Pickup System

An imaging system (surveillance camera system) may include the optical system L0 according to each example and a control unit configured to control the optical system L0. The control unit can control the optical system L0 so that each lens unit moves as described above during zooming and focusing. The control unit need not be integrated with the optical system L0, and the control unit may be separate from the optical system L0. For example, the control unit (control apparatus) may be disposed remotely from a driving unit configured to drive each lens of the optical system L0 and include a transmission unit configured to transmit a control signal (command) for controlling the optical system L0. This control unit can remotely control the optical system L0.

The control unit may include an operation unit such as a controller and buttons for remotely operating the optical system L0 and control the optical system L0 according to the user's input to the operation unit. For example, the operation unit may include an enlargement button and a reduction button. A signal may be sent from the control unit to the driving unit of the optical system L0 so as to increase the magnification of the optical system L0 in a case where the user presses the enlargement button and so as to decrease the magnification of the optical system L0 in a case where the user presses the reduction button.

The image pickup system may include a display unit such as a liquid crystal panel configured to display information (moving state) about the zoom of the optical system L0. The information about the zoom of the optical system L0 is, for example, the zoom magnification (zoom state) and a moving amount (moving state) of each lens unit. In this case, the user can remotely operate the optical system L0 through the operation unit while viewing information about the zoom of the zoom lens displayed on the display unit. The display unit and the operation unit may be integrated by adopting a touch panel or the like.

While the disclosure has been described with reference to embodiments, it is to be understood that the disclosure is not limited to the disclosed embodiments. The scope of the following claims is to be accorded the broadest interpretation so as to encompass all such modifications and equivalent structures and functions.

Each example can provide an attachment optical system that can obtain optical performance and angle of view similar to those in air when used in water.

This application claims the benefit of Japanese Patent Application No. 2022-189141, filed on Nov. 28, 2022, which is hereby incorporated by reference herein in its entirety.

What is claimed is:

1. An attachment optical system comprising:
a first optical system consisting of a dome-shaped cover attachable to an object side of an imaging optical system; and
a second optical system attachable to an image side of the imaging optical system,
wherein the following inequality is satisfied:
0.00<|fd/fc|<0.11
where fd is a focal length of the first optical system, and fc is a focal length of the second optical system.

2. The attachment optical system according to claim 1, wherein the following inequality is satisfied:
10<|(rd2+rd1)/(rd2−rd1)|<60
where rd1 is a radius of curvature of a surface on the object side of the dome-shaped cover, and rd2 is a radius of curvature of a surface on the image side of the dome-shaped cover.

3. The attachment optical system according to claim 1, wherein the following inequality is satisfied:
0.7<|(rd1−rd2)/Dd|≤1.0
where rd1 is a radius of curvature of a surface on the object side of the dome-shaped cover, rd2 is a radius of curvature of a surface on the image side of the dome-shaped cover, and Dd is a thickness of the dome-shaped cover on the optical axis.

4. An optical system comprising:
the attachment optical system according to claim 1; and
an imaging optical system.

5. The optical system according to claim 4, wherein the following inequality is satisfied:
0.5<tkw/rd1<1.0
where tkw is a distance on an optical axis from a lens surface closest to an object of the first optical system at a wide-angle end to an entrance pupil position of an optical system including all lenses from a lens closest to an object of the first optical system to a lens closest to an image side of the second optical system, and rd1 is a radius of curvature of a surface on the object side of the dome-shaped cover.

6. The optical system according to claim 4, wherein the following inequality is satisfied:
1.0<|skcw/skmw|<1.2
where skcw is an underwater distance on the optical axis from a lens surface closest to an image plane of the imaging optical system to which the attachment optical system is attached at the wide-angle end to the image plane, and skmw is an atmospheric distance on the optical axis from the lens surface closest to the image plane of the imaging optical system to which the attachment optical system is attached at the wide-angle end to the image plane.

7. The optical system according to claim 4, wherein the imaging optical system includes a focus lens unit, and the following inequality is satisfied:
0.3<dxw/dxt<1.0
where dxw is an underwater moving amount of the focus lens unit at the wide-angle end in an in-focus state at infinity relative to an atmospheric position, and dxt is an underwater moving amount of the focus lens unit at a telephoto end in the in-focus state at infinity relative to an atmospheric position.

8. The optical system according to claim 4, wherein the following inequality is satisfied:
110<2ω≤180
where ω is an atmospheric half angle of view of the imaging optical system.

9. The optical system according to claim 4, wherein the imaging optical system consists of, in order from the object side to the image side, a first lens unit having negative refractive power and a second lens unit having positive refractive power.

10. The optical system according to claim 4, wherein the imaging optical system consists of, in order from the object side to the image side, a first lens unit having negative refractive power, a second lens unit having positive refractive power, and a third lens unit having positive refractive power.

11. An image pickup apparatus comprising:
the attachment optical system according to claim 1;
the imaging optical system; and
an image sensor configured to receive image light formed by the imaging optical system.

12. An image pickup system comprising:
an optical system comprising the attachment optical system according to claim 1 and an imaging optical system; and
a control unit configured to control the optical system during zooming.

13. The image pickup system according to claim 12, wherein the control unit is separate from the optical system, and includes a transmission unit configured to transmit a control signal for controlling the optical system.

14. The image pickup system according to claim 12, wherein the control unit is separate from the optical system, and includes an operation unit for operating the optical system.

15. The image pickup system according to claim 12, further comprising a display unit configured to display information about zoom of the optical system.
